(19) United States
(12) Patent Application Publication
(10) Pub. No.: US 2024/0185729 A1
(43) Pub. Date: Jun. 6, 2024

(54) SYSTEMS AND METHODS FOR IMPLEMENTING CONDITION-BASED ACTIONS IN AN AIRCRAFT

(71) Applicant: HONEYWELL INTERNATIONAL INC., Charlotte, NC (US)

(72) Inventors: Gobinathan Baladhandapani, Madurai (IN); Pranavkumar Patel, Bangalore (IN); Sivakumar Kanagarajan, Bangalore (IN); Marc-Antoine Trupheme, Toulouse (FR)

(73) Assignee: HONEYWELL INTERNATIONAL INC., Charlotte, NC (US)

(21) Appl. No.: 18/183,455

(22) Filed: Mar. 14, 2023

(30) Foreign Application Priority Data
Dec. 1, 2022 (IN) 202211069369

(51) Int. Cl. G08G 5/00; B64D 43/00

(52) U.S. Cl. CPC G08G 5/0047; B64D 43/00; G08G 5/0034

(57) ABSTRACT

Systems and methods are provided for implementing condition-based actions in an aircraft. A flight plan received from a flight management system (FMS) is rendered on a display device. A condition and a condition-based action associated with avionic data at a point of interest selected from the flight plan is received via an onboard user device. Location data associated with the point of interest is received from at least one geospatial sensor. Current avionic data associated with the point of interest is received. A determination is made regarding whether the current avionic data fulfills the condition associated with the avionic data at the point of the interest. A notification associated with implementation of the condition-based action is displayed on the display device based on the determination.

### CROSS REFERENCE TO RELATED APPLICATION

This application claims priority to India Provisional Patent Application No. 202211069369, filed Dec. 1, 2022, the entire content of which is incorporated by reference herein.

### TECHNICAL FIELD

The present invention generally relates to aircraft operations and more particularly relates to systems and methods for implementing condition-based actions in an aircraft.

### BACKGROUND

A pilot often needs to monitor different flight related conditions and create notes as reminders to implement certain condition-based actions when certain flight related conditions are met at different points of interest. An example of a point of interest is a waypoint. These notes may be written on for example, a knee pad or a notepad. In some cases, a pilot may create notes using a shorthand that a co-pilot may have difficulty interpreting. Notes made on paper may be susceptible to being misplaced. In some cases, valuable time may be wasted as a pilot sorts through pages of notes to find the data needed with respect to a point of interest. If a pilot decides to use sticky note paper to adhere to a cockpit display device to provide reminders, the sticky note paper may fall off the cockpit display device. In addition, writing notes can be a time consuming process.

The use of digital notepads may involve a pilot sorting through multiple different instructions associated with different aspects of a flight to find and implement condition-based actions at points of interest upon the fulfillment of different flight related conditions. In some instances, the use of voice inputs to a digital notepad to specify condition-based actions at different points of interest upon the fulfillment of different flight related conditions may lead to input errors associated with speech engine inaccuracies. In addition, the use of a digital notepad may create challenges associated with the sharing of data between a pilot and a co-pilot.

In some cases, instructions received from air traffic controllers (ATC) can be played back. However, finding relevant instructions associated with implementation of condition-based actions at points of interest upon the fulfillment of different flight related conditions may involve playing back previously received ATC instructions to find the relevant instruction. In addition, all previous ATC instructions may not be stored and available for playback.

Pilot inattention due to a lack of easily accessible and timely reminders to implement condition-based actions at points of interest upon the fulfillment of different flight related conditions may lead to pilot error. Hence there is a need for systems and methods that are configured to provide reminders to implement condition-based actions at points of interest upon the fulfillment of different flight related conditions in a manner that is readily visible to both the pilot and co-pilot in a timely manner.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

An exemplary embodiment of a system includes a display device, at least one geospatial sensor, a flight management system (FMS), an onboard user input device, and a controller. The controller is configured to: render a flight plan received from the FMS on the display device; receive a condition and a condition-based action associated with avionic data at a point of interest selected from the flight plan via the onboard user device; receive location data associated with the point of interest from the at least one geospatial sensor; receive current avionic data associated with the point of interest; determine whether the current avionic data fulfills the condition associated with the avionic data at the point of the interest; and display a notification associated with implementation of the condition-based action on the display device based on the determination.

An exemplary embodiment of a method includes rendering a flight plan received from a flight management system (FMS) on a display device; receiving a condition and a condition-based action associated with avionic data at a point of interest selected from the flight plan via an onboard user device; receiving location data associated with the point of interest from at least one geospatial sensor; receiving current avionic data associated with the point of interest; determining whether the current avionic data fulfills the condition associated with the avionic data at the point of the interest; and displaying a notification associated with implementation of the condition-based action on the display device based on the determination.

Furthermore, other desirable features and characteristics of the system and method for implementing condition-based actions in an aircraft will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram representation of a system for implementing condition-based actions in accordance with an exemplary embodiment;

FIG. 2 is a block diagram representation of an aircraft including an embodiment of a condition-based action implementation system;

FIG. 3 is an illustration of an example of a navigation display page including an example of a task menu in accordance with an embodiment.

FIG. 4 is an illustration of an example of a MCDU display page including an example of a task menu in accordance with an embodiment;

FIG. 5 is an illustration of an example of a trigger condition definition page in accordance with an embodiment;

FIG. 6 is an illustration of an example of a trigger condition definition page in accordance with an embodiment;

FIG. 7 is an illustration of an example of a MCDU display page including an alert notification to implement a condition-based action associated with fulfillment of a condition at a point of interest in accordance with an embodiment;

FIG. 8 is an illustration of an example of a MCDU display page including a notification including a condition-based action associated with fulfillment of a condition at a point of interest and an execution prompt in accordance with an embodiment;

FIG. 9 is an illustration of an example of a MCDU display page including a notification indicating a condition-based action associated with fulfillment of a condition at a point of interest has been implemented in accordance with an embodiment; and

FIG. 10 is a flowchart representation of an exemplary embodiment of a method of implementing a condition-based action.

### DETAILED DESCRIPTION

The following detailed description is merely exemplary in nature. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

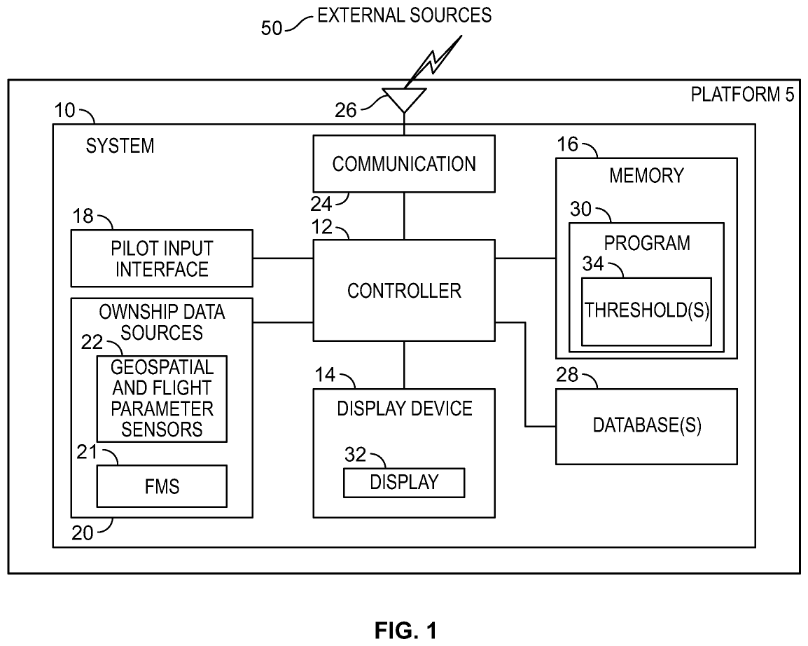

FIG. 1 is a block diagram representation of a system 10 for implementing condition-based actions (shortened herein to “system” 10), as illustrated in accordance with an exemplary and non-limiting embodiment of the present disclosure. The system 10 may be utilized onboard a mobile platform 5, as described herein. In various embodiments, the mobile platform is an aircraft, which carries or is equipped with the system 10. As schematically depicted in FIG. 1, the system 10 includes the following components or subsystems, each of which may assume the form of a single device or multiple interconnected devices: a controller circuit 12 operationally coupled to: at least one display device 14; computer-readable storage media or memory 16; an optional input interface 18, and ownship data sources 20 including, for example, a flight management system (FMS) 21 and an array of flight system status and geospatial sensors 22.

In various embodiments, the system 10 may be separate from or integrated within: the flight management system (FMS) 21 and/or a flight control system (FCS). Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the mobile platform 5.

The term “controller circuit” (and its simplification, “controller”), broadly encompasses those components utilized to carry-out or otherwise support the processing functionalities of the system 10. Accordingly, the controller circuit 12 can encompass or may be associated with a programmable logic array, application specific integrated circuit or other similar firmware, as well as any number of individual processors, flight control computers, navigational equipment pieces, computer-readable memories (including or in addition to the memory 16), power supplies, storage devices, interface cards, and other standardized components. In various embodiments, the controller circuit 12 embodies one or more processors operationally coupled to data storage having stored therein at least one firmware or software program (generally, computer-readable instructions that embody an algorithm) for carrying-out the various process tasks, calculations, and control/display functions described herein. During operation, the controller circuit 12 may be programmed with and execute the at least one firmware or software program, for example, a program 30, that embodies an algorithm described herein for receiving and processing data for implementing condition-based actions on a mobile platform 5, where the mobile platform 5 is an aircraft, and to accordingly perform the various process steps, tasks, calculations, and control/display functions described herein.

The controller circuit 12 may exchange data, including real-time wireless data, with one or more external sources 50 to support operation of the system 10 in embodiments. In this case, bidirectional wireless data exchange may occur over a communications network, such as a public or private network implemented in accordance with Transmission Control Protocol/Internet Protocol architectures or other conventional protocol standards. Encryption and mutual authentication techniques may be applied, as appropriate, to ensure data security.

The memory 16 is a data storage that can encompass any number and type of storage media suitable for storing computer-readable code or instructions, such as the aforementioned software program 30, as well as other data generally supporting the operation of the system 10. The memory 16 may also store one or more threshold 34 values, for use by an algorithm embodied in software program 30. One or more database(s) 28 are another form of storage media; they may be integrated with memory 16 or separate from it.

In various embodiments, aircraft-specific parameters and information for an aircraft may be stored in the memory 16 or in a database 28 and referenced by the program 30. Non-limiting examples of aircraft-specific information includes an aircraft weight and dimensions, performance capabilities, configuration options, and the like.

In various embodiments, two- or three-dimensional map data may be stored in a database 28, including airport features data, geographical (terrain), buildings, bridges, and other structures, street maps, and navigational databases, which may be updated on a periodic or iterative basis to ensure data timeliness. This map data may be uploaded into the database 28 at an initialization step and then periodically updated, as directed by either a program 30 update or by an externally triggered update.

Flight parameter sensors and geospatial sensors 22 supply various types of data or measurements to the controller circuit 12 during an aircraft flight. In various embodiments, the geospatial sensors 22 supply, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data.

With continued reference to FIG. 1, the display device 14 can include any number and type of image generating devices on which one or more avionic displays 32 may be produced. When the system 10 is utilized for a manned aircraft, the display device 14 may be affixed to the static structure of the Aircraft cockpit as, for example, a Head Down Display (HDD) or Head Up Display (HUD) unit. In various embodiments, the display device 14 may assume the form of a movable display device (e.g., a pilot-worn display device) or a portable display device, such as an Electronic Flight Bag (EFB), a laptop, or a tablet computer carried into the aircraft cockpit by a pilot.

At least one avionic display 32 is generated on the display device 14 during operation of the system 10; the term “avionic display” is synonymous with the term “aircraft-related display” and “cockpit display” and encompasses displays generated in textual, graphical, cartographical, and other formats. The system 10 can generate various types of lateral and vertical avionic displays 32 on which map views and symbology, text annunciations, and other graphics pertaining to flight planning are presented for a pilot to view. The display device 14 is configured to continuously render at least a lateral display showing the aircraft at its current location within the map data. The avionic display 32 generated and controlled by the system 10 can include graphical user interface (GUI) objects and alphanumerical input displays of the type commonly presented on the screens of multifunction control display units (MCDUs), as well as Control Display Units (CDUs) generally. Specifically, embodiments of the avionic displays 32 include one or more two-dimensional (2D) avionic displays, such as a horizontal (i.e., lateral) navigation display or vertical navigation display (i.e., vertical situation display VSD); and/or on one or more three dimensional (3D) avionic displays, such as a Primary Flight Display (PFD) or an exocentric 3D avionic display.

In various embodiments, a human-machine interface is implemented as an integration of a pilot input interface 18 and a display device 14. In various embodiments, the display device 14 is a touch screen display. In various embodiments, the human-machine interface also includes a separate pilot input interface 18 (such as a keyboard, cursor control device, voice input device, or the like), generally operationally coupled to the display device 14. Via various display and graphics systems processes, the controller circuit 12 may command and control a touch screen display device 14 to generate a variety of graphical user interface (GUI) objects or elements described herein, including, for example, buttons, sliders, and the like, which are used to prompt a user to interact with the human-machine interface to provide user input; and for the controller circuit 12 to activate respective functions and provide user feedback, responsive to received user input at the GUI element.

In various embodiments, the system 10 may also include a dedicated communications circuit 24 configured to provide a real-time bidirectional wired and/or wireless data exchange for the controller 12 to communicate with the external sources 50 (including, each of: traffic, air traffic control (ATC), satellite weather sources, ground stations, and the like). In various embodiments, the communications circuit 24 may include a public or private network implemented in accordance with Transmission Control Protocol/Internet Protocol architectures and/or other conventional protocol standards. Encryption and mutual authentication techniques may be applied, as appropriate, to ensure data security. In some embodiments, the communications circuit 24 is integrated within the controller circuit 12, and in other embodiments, the communications circuit 24 is external to the controller circuit 12. When the external source 50 is “traffic,” the communications circuit 24 may incorporate software and/or hardware for communication protocols as needed for traffic collision avoidance (TCAS), automatic dependent surveillance broadcast (ADSB), and enhanced vision systems (EVS).

In certain embodiments of the system 10, the controller circuit 12 and the other components of the system 10 may be integrated within or cooperate with any number and type of systems commonly deployed onboard an aircraft including, for example, an FMS 21.

The disclosed algorithm is embodied in a hardware program or software program (e.g. program 30 in controller circuit 12) and configured to operate when the aircraft is in any phase of flight. The algorithm enables a pilot to implement condition-based actions in an aircraft.

In various embodiments, the provided controller circuit 12, and therefore its program 30 may incorporate the programming instructions for: rendering a flight plan received from the FMS 21 on a display device 14; receiving a condition and a condition-based action associated with avionic data at a point of interest selected from the flight plan via a pilot input interface 18; receiving location data associated with the point of interest from at least one geospatial sensor; receiving current avionic data associated with the point of interest; determining whether the current avionic data fulfills the condition associated with the avionic data at the point of the interest; and displaying a notification associated with implementation of the condition-based action on the display device 14 based on the determination.

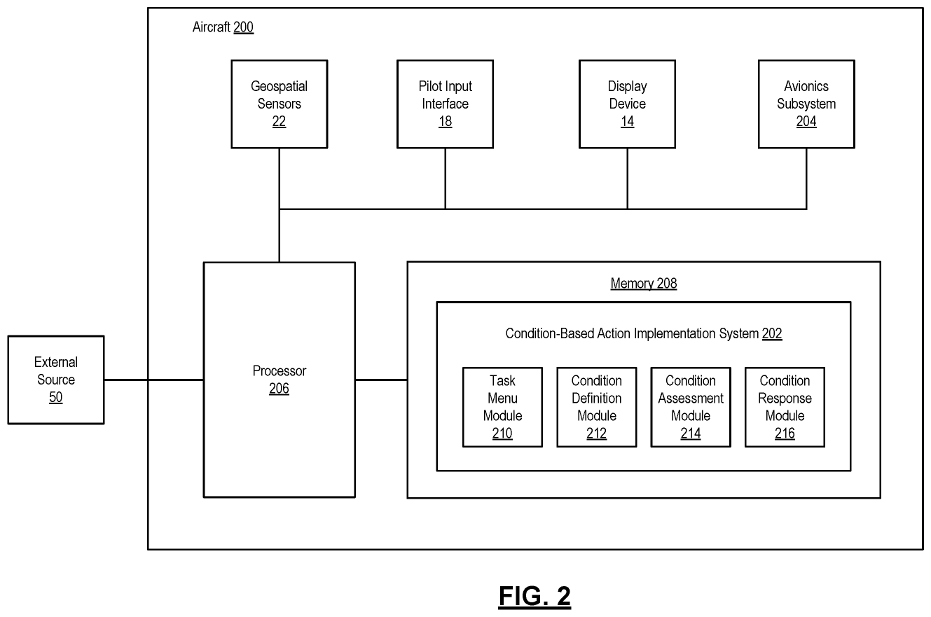

Referring to FIG. 2, a block diagram representation of an aircraft 200 including an embodiment of a condition-based action implementation system 202 is shown. The aircraft 200 is configured to be communicatively coupled to one or more external sources 50. Examples of external sources 50 include, but are not limited to, air traffic control (ATC), digital automatic terminal information service (D-ATIS), satellite weather sources, weather radars, and ground stations.

In an embodiment, the aircraft 200 includes one or more display devices 14, one or more pilot input interfaces 18, one or more geospatial sensors 22, one or more avionic subsystems 204, at least one processor 206, and at least one memory 208. The pilot input interface 18 may also be referred to as onboard user input device. Examples of avionic subsystems 204 include, but are not limited to, an interactive navigation display (INAV), an electronic flight bag (EFB), and a flight management system (FMS) 21. The aircraft 200 may include additional components, including those detailed with respect to FIG. 1, that facilitate operation of the aircraft 200.

The processor 206 is configured to be communicatively coupled to the display devices 14, the pilot input interfaces 18, the geospatial sensors 22, the avionic subsystems 204, and the memory 208. The combination of the processor 206 and the memory 208 may be referred to as a controller. The processor 206 is a programmable device that includes one or more instructions stored in or associated with the memory 208. The memory 208 includes instructions that the processor 206 is configured to execute. The memory 208 includes the condition-based action implementation system 202.

The FMS 21 is configured to provide a flight plan of the aircraft 200 to the processor 204. The processor 204 is configured to render navigational display pages and multifunction control display unit (MCDU) display pages that include various representations of the flight plan for display on one or more of the display devices 14. The displays of the flight plan include points of interest. One or more of the points of interests may be specific waypoints on the flight plan. The geospatial sensors 22 are configured to provide location data of the aircraft 200 to the processor 206. The processor 206 is configured to indicate a location of the aircraft 200 based on the received location data on the navigational display pages and the MCDU display pages.

In an embodiment, an external source 50 is configured to provide avionic data to the processor 206. Examples of avionic data received from an external source 50 include, but are not limited to, weather data, Web based services, data upload through a connection to the FMS 21, and pilot report (PIREP) data. In an embodiment, an avionic subsystem 204 is configured to provide avionic data to the processor 206. Examples of avionic data received from an avionic subsystem include, but are not limited to, aircraft altitude, traffic data from a transponder, traffic collision avoidance system (TCAS), weather data from a weather radar, runway information from automatic terminal information service (ATIS) via COM radio. Examples of avionic data also include, but are not limited to, FMS data, a weather data, QNH data, and external environment data.

In an embodiment, the condition-based action implementation system 202 includes a task menu module 210, a condition definition module 212, a condition assessment module 214, and a condition response module 216. The condition-based action implementation system 202 may include additional components that facilitate operation of the condition-based action implementation system 202.

The task menu module 210 is configured to detect when a point of interest has been selected from a display of the representation of the flight plan on a display device 14 via a pilot input interface 18 and generate a task menu associated with the selected point of interest. Examples of the display include a navigation display page and a MCDU display page. An example of a user is a pilot of the aircraft 200. In an embodiment, the task menu includes the selected point of interest, an option to add a task that includes a condition and a condition-based action associated with avionic data at the selected point of interest, and an option to delete the task menu. In an embodiment, the task menu overlays at least a portion of the display including the representation of the flight plan.

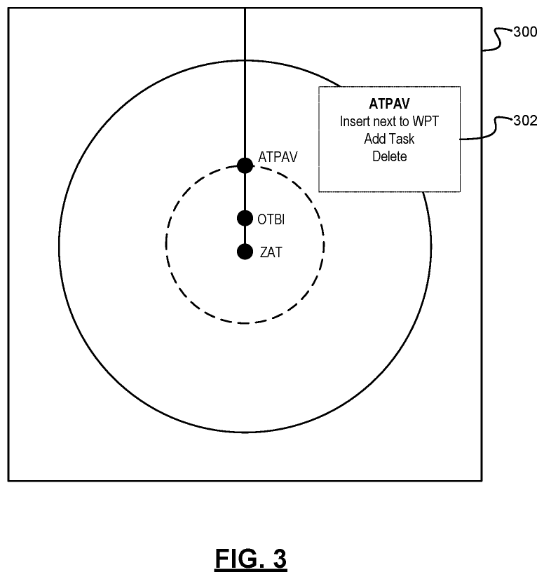

Referring to FIG. 3, an illustration of an example of a navigation display page 300 including an example of a task menu 302 in accordance with an embodiment is shown. A flight plan generated by the FMS 21 is shown on the navigation display page 300. The flight plan includes several different waypoints ZAT, OTBI, and ATPAV. In the example, a pilot has selected the waypoint ATPAV as a point of interest from the navigation display page 300 displayed on a display device 14 via a pilot input interface 18. The task menu module 210 detected the selection of the waypoint ATPAV from the navigation display page 300 and generated the task menu 302 associated with the selected waypoint ATPAV for display on the navigation display page 300. The task menu 302 includes the selected waypoint ATPAV, an option to add a task that includes a condition and a condition-based action associated with avionic data at the selected waypoint ATPAV, and an option to delete the task menu 302.

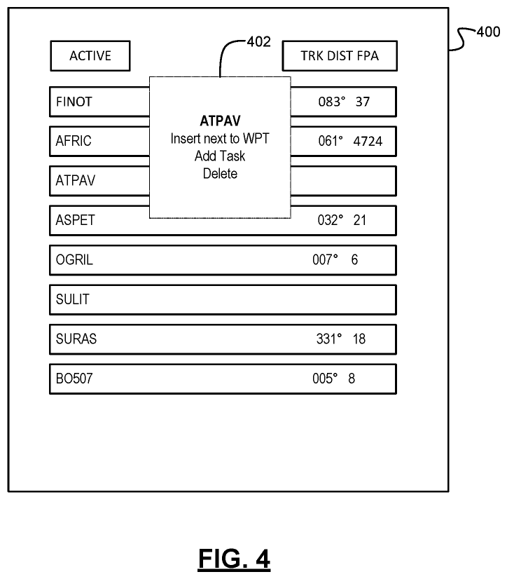

Referring to FIG. 4, an illustration of an example of a MCDU display page 400 including an example of a task menu 402 in accordance with an embodiment is shown. A flight plan generated by the FMS 21 includes several different waypoints FINOT, AFRIC, ATPAV, ASPET, OGRIL, SULIT, SURAS, and BO507. In the example, a pilot has selected the waypoint ATPAV as a point of interest from the MCDU display page 400 displayed on a display device 14 via a pilot input interface 18. The task menu module 210 detected the selection of the waypoint ATPAV from the MCDU display page 400 and generated the task menu 402 associated with the selected waypoint ATPAV for display on the MCDU display page 400. The task menu 402 includes the selected waypoint ATPAV, an option to add a task that includes a condition and a condition-based action associated with avionic data at the selected waypoint ATPAV, and an option to delete the task menu 402.

Referring back to FIG. 2, the condition definition module 212 is configured to detect selection of the option to add a task that includes a condition and a condition-based action associated with avionic data at the selected point of interest via the pilot input interface 18 and generate a trigger condition definition page associated with the selected point of interest for display on a display device 14. The trigger condition definition page includes the selected point of interest and a trigger condition definition field. In an embodiment, the trigger condition definition field enables a user to define an avionic data, enter a condition associated with the avionic data, and a condition-based action for implementation if the condition associated with the avionic data is fulfilled.

In an embodiment, the user is provided with a list of selectable pre-defined conditions associated with avionic data on the trigger condition definition page. The user is provided with the option of selecting a pre-defined condition associated with the avionic data and associating a user provided condition-based action for association with the selected pre-defined condition at the selected point of interest. In an embodiment, the user is provided with the option of providing a customized condition associated with the avionic data and associating a user provided condition-based action for association with the customized condition at the selected point of interest.

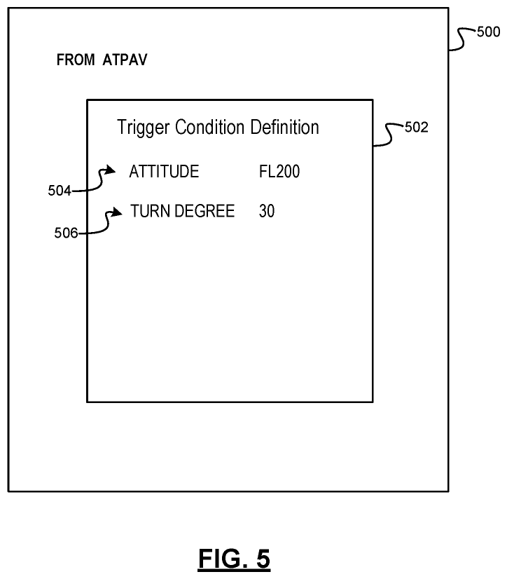

Referring to FIG. 5, an illustration of an example of a trigger condition definition page 500 including an example of a trigger condition definition field 502 in accordance with an embodiment is shown. The condition definition module 212 detected that a user selected the option to add a task that includes a condition and a condition-based action associated with avionic data at the selected point of interest ATPAV via the pilot input interface 18 and generated a trigger condition definition page 500 associated with the selected point of interest ATPAV for display on a display device 14. The trigger condition definition page 500 includes the selected point of interest ATPAV and a trigger condition definition field 502. The user entered a customized condition 504 via the pilot input interface 18. In the example, the customized condition 504 is whether the aircraft 200 will be at a flight altitude of 200FL at the point of interest ATPAV. The user then provided a condition-based action 506 for association with the customized condition at the selected point of interest ATPAV. In the example, the condition-based action 506 is to implement a turn degree 30. In other words, the entry on the trigger condition definition page 500 specifies that when the aircraft 200 arrives at the point of interest ATPAV, if the flight altitude of the aircraft 200 is FL200, the condition-based action 506 for implementation will be to implement a turn degree of 30. In this example, the avionic data is FMS avionic data. The flight altitude data may be received from the FMS 21.

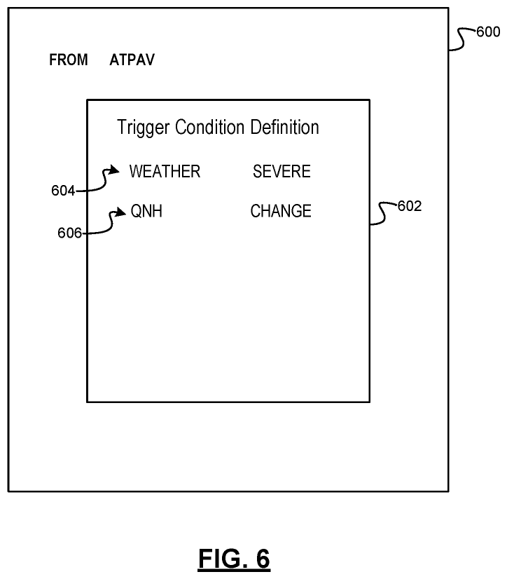

Referring to FIG. 6, an illustration of an example of a trigger condition definition page 600 including an example of a trigger condition definition field 602 in accordance with an embodiment is shown. The condition definition module 212 detected that a user selected the option to add a task that includes a condition and a condition-based action associated with avionic data at the selected point of interest ATPAV via the pilot input interface 18 and generated a trigger condition definition page 600 associated with the selected point of interest ATPAV for display on a display device 14. The trigger condition definition page 600 includes the selected point of interest ATPAV and a trigger condition definition field 602. The user entered a customized condition 604 via the pilot input interface 18. In the example, the customized condition 504 is whether the weather will be severe at the point of interest ATPAV. The user then provided a condition-based action 606 for association with the customized condition at the selected point of interest ATPAV. In the example, the condition-based action 606 is to implement a QNH change. In other words, the entry on the trigger condition definition page 600 specifies that when the aircraft 200 arrives at the point of interest ATPAV, if the weather is severe, the condition-based action 606 for implementation will be to implement a QNH change in accordance with the severe weather conditions. The weather data may be received from a weather radar. The change in the QNH may be received from an external source such as for example, from a D-ATIS or an ATC. In this example, the avionic data is the weather data.

Referring back to FIG. 2, the condition assessment module 214 is configured to receive location data from the geospatial sensors 22. When the condition assessment module 214 determines that the received location data corresponds to a point of interest associated with a condition and a condition-based action, the condition assessment module 214 identifies the avionic data associated with the condition. The condition assessment module 214 assesses the identified avionic data to determine whether the current avionic data at the point of interest fulfils the condition associated with the avionic data. If the condition assessment module 214 determines that the current avionic data at the point of interest fulfils the condition associated with the avionic data, the condition assessment module 214 is configured to notify the condition response module 216.

For example, with reference to FIG. 5, when the aircraft 200 arrives at the point of interest ATPAV, the condition is whether the flight altitude of the aircraft 200 is FL200. The condition assessment module 214 identifies flight altitude received from the FMS 21 as the avionic data associated with the condition. The condition assessment module 214 assesses the current flight altitude data received from the FMS 21 at the point of interest to determine whether the flight altitude is FL200. If the condition assessment module 214 determines that the current flight altitude of the aircraft 200 is FL200 at the point of interest ATPAV, the current flight altitude fulfils the condition and the condition assessment module 214 is configured to notify the condition response module 216.

Referring back to FIG. 2, if the condition assessment module 214 determines that the current avionic data at the point of interest fulfils the condition associated with the avionic data and notifies the condition response module 216, the condition response module 216 is configured to display a notification associated with implementation of the condition-based action associated with the fulfilled condition at the point of interest. In an embodiment, the displayed notification may initially be presented as a blinking notification. If the pilot fails to respond to the notification within a pre-defined period of time, the notification may be escalated to, for example, an audio notification.

In an embodiment, the condition response module 216 is configured to display an alert notification on a display device 14 to implement the condition-based action associated with fulfillment of the condition at the point of interest.

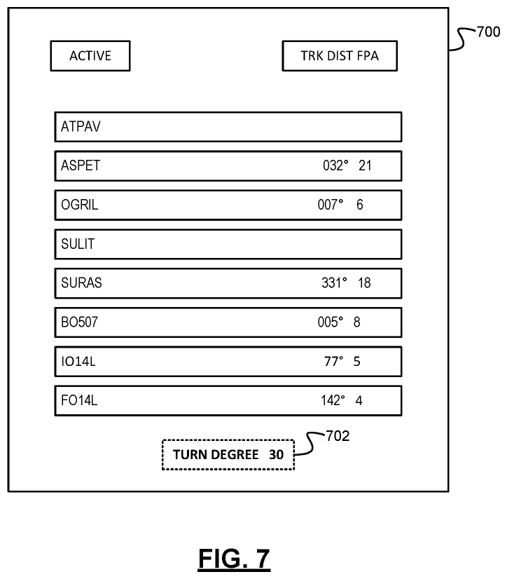

Referring to FIG. 7, an illustration of an example of a MCDU display page 700 including an alert notification 702 with instructions to the pilot to implement a condition-based action associated with fulfillment of the condition at the point of interest ATPAV in accordance with an embodiment is shown. With continuing reference to example described with respect to FIG. 5, upon a determination by the condition assessment module 214 that the flight altitude of FL200 of the aircraft 200 at the point of interest ATPAV fulfils the condition defined in FIG. 5, the condition assessment module 214 notifies the condition response module 216. In the example, the condition response module 216 displays an alert notification on a MCDU display page 700 on a display device 14 implement the condition-based action 702 of implementing a turn degree of 30.

In an embodiment, the condition response module 216 is configured to display a notification that includes the condition-based action associated with fulfillment of the condition at the point of interest and an execution prompt on a display device 14. A user is provided with the option of providing an execution command to implement the condition-based action by activating the execute prompt. The condition-based action is implemented responsive to activation of the execute prompt.

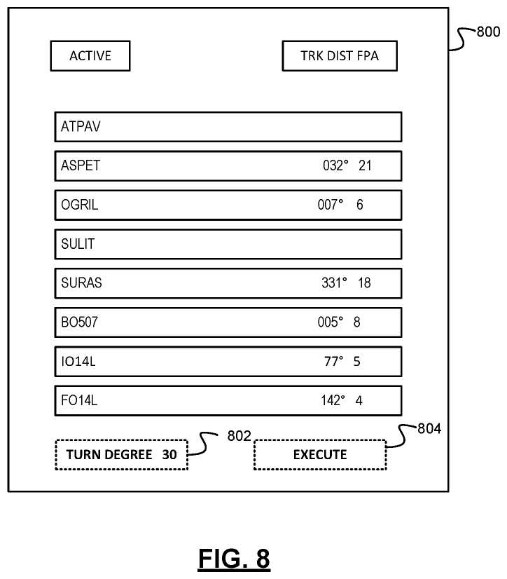

Referring to FIG. 8, an illustration of an example of a MCDU display page 800 including a notification including a condition-based action 802 associated with fulfillment of a condition at a point of interest ATPAV and an execution prompt 804 in accordance with an embodiment is shown. With continuing reference to example described with respect to FIG. 5, upon a determination by the condition assessment module 214 that the flight altitude of FL200 of the aircraft 200 at the point of interest ATPAV fulfils the condition defined in FIG. 5, the condition assessment module 214 notifies the condition response module 216. In the example, the condition response module 216 displays the condition-based action 802 of implementing a turn degree of 30 associated with fulfillment of a condition at a point of interest ATPAV and an execution prompt 804. The pilot is provided with the option of providing an execution command to implement the condition-based action 802 of implementing a turn degree of 30 by activating the execute prompt 804.

In an embodiment, the condition response module 216 is configured to automatically implement the condition-based action associated with fulfillment of the condition at a point of interest and display a notification on a display device 14 indicating that the condition-based action has been implemented. Following implementation of the condition-based action, the condition response module 216 is configured to display a notification indicating that the condition-based action has been implemented.

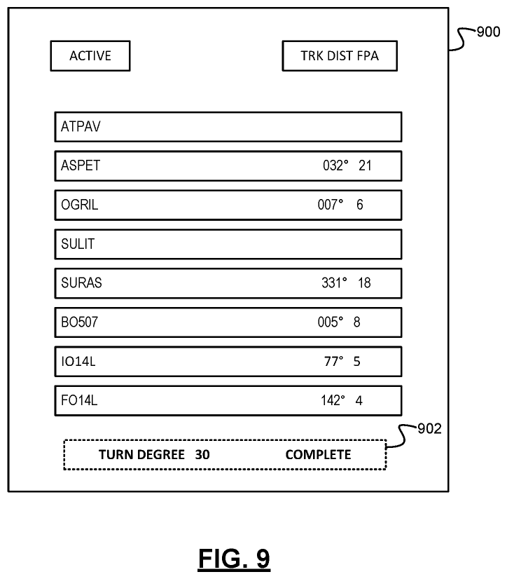

Referring to FIG. 9, an illustration of an example of a MCDU display page 900 including a notification 902 indicating a condition-based action associated with fulfillment of a condition at a point of interest ATPAV has been implemented in accordance with an embodiment is shown. With continuing reference to example described with respect to FIG. 5, upon a determination by the condition assessment module 214 that the flight altitude of FL200 of the aircraft 200 at the point of interest ATPAV fulfils the condition defined in FIG. 5, the condition assessment module 214 notifies the condition response module 216. In the example, the condition response module 216 automatically implements the condition-based action of implementing a turn degree of 30 associated with fulfillment of the condition at the point of interest ATPAV and displays a notification 902 on the MCDU display page 900 indicating that the condition-based action of implementing a turn degree of 30 has been completed.

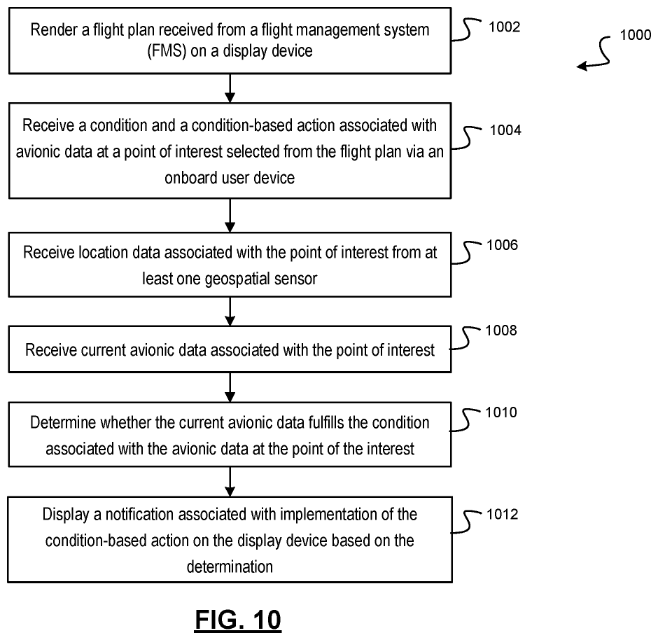

Referring to FIG. 10, a flowchart representation of an exemplary embodiment of a method 1000 of implementing a condition-based action is shown. At 1002, a flight plan received from a flight management system (FMS) 21 is rendered on a display device 14. At 1004, a condition and a condition-based action associated with avionic data at a point of interest selected from the flight plan is received via an onboard user device 18. At 1006, location data associated with the point of interest is received from at least one geospatial sensor 22. At 1008, current avionic data associated with the point of interest is received. At 1010, a determination is made regarding whether the current avionic data fulfills the condition associated with the avionic data at the point of the interest. At 1012, a notification associated with implementation of the condition-based action is displayed on the display device 14 based on the determination.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system comprising:
a display device;
at least one geospatial sensor;
a flight management system (FMS);
an onboard user input device; and
a controller configured to:
render a flight plan received from the FMS on the display device;
receive a condition and a condition-based action associated with avionic data at a point of interest selected from the flight plan via the onboard user device;
receive location data associated with the point of interest from the at least one geospatial sensor;
receive current avionic data associated with the point of interest;
determine whether the current avionic data fulfills the condition associated with the avionic data at the point of the interest; and
display a notification associated with implementation of the condition-based action on the display device based on the determination.

2. The system of claim 1, wherein the controller is configured to render the flight plan on one of a navigation display page and a multifunction control display unit (MCDU) display page.

3. The system of claim 1, wherein a controller is configured to receive a selection of the condition associated with the avionic data at the point of interest from at least one selectable pre-defined condition associated with the avionic data via the onboard user device.

4. The system of claim 1, wherein controller is configured to receive a customized condition as the condition associated with the avionic data at the point of interest via the onboard user device.

5. The system of claim 1, wherein the controller is configured to generate a task menu to overlay at least a portion of the flight plan on the display device in response to selection of the point of interest from the flight plan, the task menu including an option to add the condition and the condition-based action associated with the avionic data for association with the selected point of interest.

6. The system of claim 1, wherein the controller is configured to:
render a trigger condition definition page on the display device in response to selection of the point of interest from the flight plan; and
receive the condition and the condition-based action associated with the avionic data via the trigger condition definition page.

7. The system of claim 1, wherein the controller is configured to display the notification on the display device as an alert notification to implement the condition-based action associated with fulfillment of the condition associated with the avionic data at the point of interest.

8. The system of claim 1, wherein the controller is configured to:
automatically implement the condition-based action associated with the avionic data at the point of interest upon a determination that the current avionic data fulfills the condition associated with the avionic data; and
display the notification on the display device to indicate that the condition-based action has been implemented.

9. The system of claim 1, wherein the controller is configured to:
display the notification on the display device to include an execution prompt to enable implementation of the condition-based action associated with the avionic data at the point of interest upon a determination that the current avionic data fulfills the condition associated with the avionic data;
determine whether an execution command has been received in response to the execution prompt via the onboard user input device; and
execute the condition-based action based on the determination.

10. The system of claim 1, wherein the avionic data is one of FMS data, weather data, QNH data, aircraft altitude, traffic data from a transponder, traffic collision avoidance system (TCAS), weather data from a weather radar, runway information from automatic terminal information service (ATIS) via COM radio, Web based services, data upload through a connection to the FMS, and pilot report (PIREP) data, and external environment data.

11. A method comprising:
rendering a flight plan received from a flight management system (FMS) on a display device;
receiving a condition and a condition-based action associated with avionic data at a point of interest selected from the flight plan via an onboard user device;
receiving location data associated with the point of interest from at least one geospatial sensor;
receiving current avionic data associated with the point of interest;
determining whether the current avionic data fulfills the condition associated with the avionic data at the point of the interest; and
displaying a notification associated with implementation of the condition-based action on the display device based on the determination.

12. The method of claim 11, further comprising rendering the flight plan on one of a navigation display page and a multifunction control display unit (MCDU) display page.

13. The method of claim 11, further comprising receiving a selection of the condition associated with the avionic data from at least one selectable pre-defined condition associated with the avionic data via the onboard user device.

14. The method of claim 11, further comprising receiving a customized condition as the condition associated with the avionic data via the onboard user device.

15. The method of claim 11, further comprising generating a task menu to overlay at least a portion of the flight plan on the display device in response to selection of the point of interest from the flight plan, the task menu including an option to add the condition and the condition-based action associated with the avionic data for association with the selected point of interest.

16. The method of claim 11, further comprising:
rendering a trigger condition definition page on the display device in response to selection of the point of interest from the flight plan; and
receiving the condition and the condition-based action associated with the avionic data at the point of interest via the trigger condition definition page.

17. The method of claim 11, further comprising displaying the notification on the display device as an alert notification to implement the condition-based action associated with fulfillment of the condition associated with the avionic data at the point of interest.

18. The method of claim 11, further comprising:
automatically implementing the condition-based action associated with the avionic data at the point of interest upon a determination that the current avionic data fulfills the condition associated with the avionic data; and
displaying the notification on the display device to indicate that the condition-based action has been implemented.

19. The method of claim 11, further comprising:
displaying the notification on the display device to include an execution prompt to enable implementation of the condition-based action associated with the avionic data at the point of interest upon a determination that the current avionic data fulfills the condition associated with the avionic data;
determining whether an execution command has been received in response to the execution prompt via the onboard user input device; and
executing the condition-based action based on the determination.

20. The method of claim 11, wherein the avionic data is one of FMS data, weather data, QNH data, aircraft altitude, traffic data from a transponder, traffic collision avoidance system (TCAS), weather data from a weather radar, runway information from automatic terminal information service (ATIS) via COM radio, Web based services, data upload through a connection to the FMS 21, and pilot report (PIREP) data, and external environment data.
